(19) United States
(12) Patent Application Publication
(10) Pub. No.: US 2021/0395458 A1
(43) Pub. Date: Dec. 23, 2021

(54) POLYAMIC ACID RESIN IN REACH-APPROVED SOLVENT SYSTEM FOR WIRE COATING APPLICATIONS

(71) Applicant: KANEKA AMERICAS HOLDING, INC., Pasadena, TX (US)

(72) Inventors: Paul MELONI, Pasadena, TX (US); Haibin ZHENG, Pasadena, TX (US)

(73) Assignee: KANEKA AMERICAS HOLDING, INC., Pasadena, TX (US)

(21) Appl. No.: 17/279,868

(22) PCT Filed: Sep. 30, 2019
(86) PCT No.: PCT/US2019/053855

§ 371 Date: Mar. 25, 2021

Related U.S. Application Data
(60) Provisional application No. 62/738,106, filed on Sep. 28, 2018.

(51) Int. Cl. C08G 73/10; C09D 5/03; C09D 179/08; C09D 7/20; H01B 3/30

(52) U.S. Cl. CPC C08G 73/1032; C08G 73/1071; C09D 5/03; H01B 13/06; C09D 7/20; H01B 3/305; C09D 179/08

(57) ABSTRACT

The present invention discloses a polyamic acid resin composition in a REACH-approved solvent system for use in wire coating applications. The polyamic acid resin composition comprises a molecular weight greater than 8,000 grams per mole, more preferably greater than 20,000 grams per mole. The REACH-approved solvent system comprising a primary REACHapproved solvent with one or more optional secondary REACH-approved co-solvents. The secondary REACH-approved co-solvent can be reactive or non-reactive with dianhydride. The present invention also discloses the elimination of solvents in polyamic acid resin to produce a REACH-approved polyamic acid resin powder.

### REFERENCES CITED

### Patent Literature

Patent Literature 1: TW Patent Application No. 09514664
Patent Literature 2: U.S. Pat. No. 8,735,534
Patent Literature 3: U.S. patent application Ser. No. 14,343,745
Patent Literature 4: U.S. Pat. No. 3,179,634

### Non-Patent Literature

Non Patent Literature 1: Nicholson, Lee M. et al. The Role of Molecular Weight and Temperature on the Elastic and Viscoelastic Properties of a Glassy Thermoplastic Polyimide, Hampton, Va.: National Aeronautics and Space Administration, Langley Research Center.

### FIELD OF THE INVENTION

The present invention discloses a polyamic acid resin solvated in an solvent system that is compliant with REACH environmental regulations for use in wire coating applications. In particular, the present invention discloses a REACH-approved solvent system and corresponding polyamic acid resin composition with excellent material properties and compatibility with current wire coating processes and equipment. Furthermore, the invention discloses a solvent free resin powder that is complaint with REACH environmental regulations and can be dissolved in a solvent of choice.

### BACKGROUND OF THE INVENTION

Polyimides have been a preferable choice for highly demanding environments due to their excellent electrical, chemical, mechanical, and thermal properties. One important use of polyimides is in the coating of wires and is referred to as a resin or enamel coating. The resin coating is typically applied to a surface or wire as a solvent coating of polyamic acid and then thermally polymerized by a condensation reaction to polyimide. A polyimide coating on a wire provides dielectric insulation to protect the wire in highly demanding environments.

Current product offerings use polar aprotic solvents such as N-methylpyrrolidone, N—N-dimethylacetamide, or dimethylformamide to solvate the polyamic acid. The polyamic acid resin is produced by added an equimolar amount of dianhydride to a solvated diamine at temperatures below 60° C. The resulting polyamic acid solution is then mixed for an appropriate amount of time and the viscosity of the solution increases. The increase in viscosity of the solution is due to increase in the concentration of polyamic acid in the solution. Current industrial processes and equipment have been built to handle specific concentrations of polyamic acid at specific viscosities to create successful wire coatings.

Unfortunately, the current solvents of choice are not approved by the European Union Chemicals Agency under the Registration, Evaluation, Authorization, Restriction of Chemicals (REACH) regulation. The REACH regulation aims to improve human health and the environment within the European Union. The solvents currently used in industry, such as N-methylpyrrolidone, N—N-dimethylacetamide, or dimethylformamide, are associated with infertility, harm to unborn children, and irritation of the lungs, skin, and eyes. There is currently no alternative solvent system that complies with the REACH regulation.

The polar aprotic solvent dimethyl sulfoxide is REACH-approved, but when used with equimolar amounts of dianhydride and diamine, the viscosity is extremely high relative to the concentration of polyamic acid. Extremely high viscosity is not compatible with the current wire coating processes and equipment. Furthermore, the extremely high viscosity is not effective as a wire coating due to poor adhesion to the wire surface. Thus, dimethyl sulfoxide alone, without further alterations to the polyamic acid resin composition, is not a sufficient solution.

Attempts to control viscosity have been made, but are not compatible with existing equipment and processes used in the wire coating industry. Patent Literature 1 teaches the creation of an amic acid oligomer with a dianhydride converted to two terminal amino ester groups (—C(O)OR) and two carboxyl esters (—C(O)OH), which creates a relatively stable amic acid oligomer system at lower viscosity. However, this system requires converting the esters back to anhydrides during the thermal curing process, which is a slow reaction and not compatible with existing wire coating processes. The patent application teaches a curing process that takes several hours at temperatures above 250° C. to create polyimide. The process used currently in industry requires thermal curing in 5 to 15 minutes per pass to produce an economically viable product.

Another option for a REACH-approved solvent system is taught in Patent Literature 2. Patent Literature 2 teaches using esters (—C(O)OR) and/or (—C(O)OH) creating relatively stable amic acid oligomers that are chemically cured with a dehydrating agent at lower temperatures to create polyimides. However, this method is not compatible with currently used wire coating processes. In industry, a bath or dip coating process is used. Use of a dehydrating agent would not allow for a proper coating on the surface of the wire. The bath would imidize too early, which would make it difficult to apply a coating to the wire without costly equipment and significant process modifications.

A final option is presented in Patent Literature 3, which teaches a water based polyimide precursor solution. Current wire coating methods use polyamic acid in solvent systems that would gel and precipitate if exposed to a water based system, which ruins the resin. It is common in the wire coating industry for one supplier to produce a number of different resins with differing concentrations, viscosities, and solvents to meet their customer's demands. A water based solution would introduce water into the production facility, potentially harming other products produced within the facility. A water based solution is not compatible with most current polyimide production facilities.

The present invention aims to provide a polyamic acid resin in a REACH-approved solvent system that is fully compatible with current wire coating processes, equipment, and facilities.

### SUMMARY OF THE INVENTION

The present invention discloses two embodiments for the elimination of non-REACH-approved solvents for polyamic acid resin. The first embodiment teaches a polyamic acid resin composition for use with a REACH-approved solvent system. The viscosity and concentration of the resin system is controlled to match existing equipment and processes for wire coating by adjusting the molar ratio of the dianhydride to the diamine. The second embodiment teaches the elimination of solvents to produce a polyamic acid resin powder. The polyamic acid resin powder would be approved by the REACH regulation and dissolvable in either REACH-approved or non-REACH-approved solvents.

As taught throughout the prior art, such as Patent Literature 4, polyamic acid is formed by the reaction of a dianhydride with a diamine. The prior art teaches a equimolar composition of dianhydride to diamine to form polyamic acid with desirable characteristics. However, the equimolar composition taught in the prior art results in extremely high viscosity in REACH-approved solvent systems, such as dimethyl sulfoxide. Extremely high viscosity is not desirable because it is not compatible with currently used processes and equipment. Furthermore, high viscosity polyamic acid resins adhere poorly to wire.

The present invention discloses a composition of polyamic acid resin with a molar ratio of dianhydride to diamine that is less than the preferred 1:1 molar ratio taught throughout the prior art. Decreasing this molar ratio of dianhydride to diamine as taught by the present invention significantly decreases the molecular weight of the resulting polyamic acid. Non-Patent Literature 1 describes diminishing material properties of polyimides as the molecular weight of the polyimide decreases. Inventors found that, contrary to Non-Patent Literature 1, the lower molecular weight polyamic acid resin according to the present invention retained desirable material properties despite a decrease in the molecular weight of the polyamic acid.

### DETAILED DESCRIPTION OF THE INVENTION

According to the first embodiment of the present invention, the molar ratio is reduced below an equimolar ratio of dianhydride to diamine to reach a molecular weight of the polyamic acid resin above 8,000 grams per mole, more preferably above 20,000 grams per mole. The molar ratio of dianhydride to diamine can vary, depending on the molecular weight of dianhydride and diamine used. Reducing the molar ratio of dianhydride to diamine will allow for viscosity adjustments in REACH-approved solvents, such as dimethyl sulfoxide, that produce high viscosity polyamic acid resins with equimolar compositions of dianhydride and diamine. Viscosity of the polyamic acid resin is reduced to between 5 and 500 poise. Reducing the viscosity allows for the system described in the present invention to be compatible with existing wire coating processes and equipment.

Examples of dianhydride compatible with the first embodiment of the present invention include, but are not limited to pyromellitic dianhydride, 2,3,6,7-naphthalenetetracarboxylic dianhydride, 3,3′,4,4′-biphenyltetracarboxylic dianhydride, 1,2,5,6-naphthalenetetracarboxylic dianhydride, 2,2′, 3,3′-biphenyltetracarboxylic dianhydride, 3,3′4,4′-benzophenonetetracarboxylic dianhydride, 2,2-bis(3,4-dicarboxyphenyl)propane dianhydride, 3,4,9,10-perylenetetracarboxylic dianhydride, bis(3,4-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)ethane dianhydride, oxydiphthalic dianhydride, bis(3,4-dicarboxyphenyl)sulfone dianhydride, p-phenylenebis (trimellitic acid monoester acid anhydride), ethylenebis(trimellitic acid monoester acid anhydride), (bisphenol A)bis(trimellitic acid monoester acid anhydride), and analogs thereof. The dianhydrides listed may be used alone or in combination of two or more.

Examples of diamine include, but are not limited to 4,4′-diaminodiphenylpropane, 4,4′-diaminodiphenylmethane, 3,3′-dimethylbenzidine, 3,3′-dimethoxybenzidine, 3,3′-dichlorobenzidine, 4,41-diaminodiphenyl sulfide, 3,3′-diaminodiphenylsulfone, 4,4′-diaminodiphenylsulfone, 4,4′-diaminodiphenyl ether, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl-N-methylamine, 4,4′-diaminodiphenyl-N-phenylamine, 1,4-diaminobenzene (p-phenylenediamine), 1,3-diaminobenzene, 1,2-diaminobenzene, and analogs thereof. The diamines listed may be used alone or in combination of two or more.

The solvent system according to the first embodiment of the present invention comprises of a primary REACH-approved solvent and an optional secondary REACH-approved co-solvent. Equal to or more than 80 weight percent, including 100 weight percent, of the solvent system must consist of the primary REACH-approved solvent. Equal to or less than 20 weight percent, including 0 weight percent, of the solvent system consists of one or more of the secondary REACH-approved co-solvents.

Examples of primary REACH-approved solvents include, but are not limited to dimethyl sulfoxide, hexamethylphospharamide, and γ-butyrolactone.

The optional secondary REACH-approved co-solvent can be either a non-reactive or reactive with dianhydride. Examples of non-reactive secondary REACH-approved co-solvents include, but are not limited to xylene, aromatic naphtha, acetone, and 1,3-dioxolane.

Reactive secondary REACH-approved co-solvents react with the dianhydride to form an ester in cis or trans conformation according to the following reaction. The co-solvent will have a nucleophile component such as an OH— group on an alcohol. The nucleophile will react with the carbonyl groups on the dianhydride to open the rings and complex. Due to symmetry on the dianhydride, the formation of esters can either be cis or trans symmetry.

The ester formation lowers the viscosity and molecular weight of the resin at temperatures below 100° C. This reduction is due to shortened polyamic acid chains, caused by a portion of the available dianhydride reacting with the reactive secondary REACH-approved co-solvent. At curing temperatures above 100° C., the dianhydride is released from the ester and the molecular weight and viscosity increase as the polyamic acid chains increase in length with the released dianhydride.

Examples of reactive optional secondary REACH-approved co-solvents include, but are not limited to protic solvents such as hexanol, 2-ethyl-1-butanol, 2-ethyl-1-hexanol, propanol, isopropanol, ethanol, and methanol.

Additionally, the composition of the solvent system can also optionally contain an additive that is commonly known to a person having ordinary skill in the art to be suitable for the production of polyamic acid resin. For example, additives including, but not limited to hydrophobic non-ionic ethoxylates and alcohols and siloxanes can be added to adjust surface tensions and improve wettability in coating applications.

In addition to the polyamic acid resin composition taught in the present invention, the solvent system is compatible with commercially available polyamic acid materials including, but not limited to IST RC-5019, IST RC-5057, IST RC-5069, and IST RK-5097.

The polyamic acid resin disclosed in the present invention may be prepared by any method that is known to a person of ordinary skill in the art. For example, the polyamic acid resin may be prepared by adding the desired solvent system to a reactor and setting the reactor temperature to 20° C. Adding diamine to reactor and agitating the solution at 500 rpm until dissolved. Progressively adding dianhydride, in an amount that yields a molar ratio of dianhydride to diamine added that is between 0.95:1 and 0.99:1, preferably between 0.96:1 and 0.99:1, to the reactor during a period of 45 minutes with agitation speeds between 500 rpm and 800 rpm. Further agitating the solution for three hours at 300 rpm.

The second embodiment of the present invention provides a resin powder with only trace amounts of solvent remaining. The polyamic acid resin powder can be optionally made according to the first embodiment, using non-equimolar amounts of dianhydride and diamine to control the viscosity of the solution. The polyamic acid resin powder can be dissolved in a solvent system of choice. This includes non-REACH-approved solvents including, but not limited to N-methylpyrrolidone, N—N-dimethylacetamide, or dimethylformamide. The resin formed by dissolving polyamic acid resin powder in solvent can be utilized in wire coating applications. The polyamic acid resin powder is compatible with existing wire coating processes. The polyamic acid resin powder, regardless of the solvent the resin polyamic acid was originally formed in, is REACH-approved due to only trace amounts of the solvent remaining.

The polyamic acid resin powder according to the second embodiment of the present invention can be prepared by any method that is known to a person of ordinary skill in the art for the removal of solvent from polyamic acid resin. For example, a resin polyamic acid can be precipitated in water by adding the resin to a mixer filled with water at high agitation speeds. The precipitated polyamic acid can be collected, washed multiple times in water to remove additional solvent, and then dried in a vacuum oven at temperatures below 60° C. The dried polyamic acid can then be collected and is capable of being dissolved in a REACH-approved solvent.

### EXAMPLES

The following examples illustrate the method for preparing the polyamic acid resin in a REACH-approved solvent system according to the first embodiment of the of the present invention. Furthermore, the following examples illustrate the retention of material properties of the resin with decreasing molecular weight, relatively low viscosity of the resin, and successful adhesion to wire of the resin in the first embodiment of the present invention.

### Example 1

Example 1 is prepared by adding dimethyl sulfoxide to a reactor and setting the reactor temperature to 20° C. Adding 4,4′-diaminodiphenyl ether to reactor and agitating the solution at 100 rpm until dissolved. Progressively adding pyromellitic dianhydride, in an amount that yields a molar ratio of pyromellitic dianhydride to 4,4′-diaminodiphenyl ether added that is 0.97:1, to the reactor during a period of 45 minutes with agitation speeds between 10 to 100 rpm. Further agitating the solution for three hours at 10 rpm.

The method described in Example 1 is a preferred method for making solvent based systems.

### Example 2

Example 2 is prepared using a method similar to Example 1, except pyromellitic dianhydride is added to yield a molar ratio of pyromellitic dianhydride to 4,4′-diaminodiphenyl ether added that is 0.98:1.

### Example 3

Example 3 is prepared using a method similar to Example 1, except pyromellitic dianhydride is added to yield a molar ratio of pyromellitic dianhydride to 4,4′-diaminodiphenyl ether added that is 0.995:1.

### Example 4

Example 4 is prepared using a method similar to Example 1, except pyromellitic dianhydride is added to yield a molar ratio of pyromellitic dianhydride to 4,4′-diaminodiphenyl ether added that is 0.96:1.

### Example 5

Example 5 is prepared using a method similar to Example 1, except the solvent system 4,4′-diaminodiphenyl ether is dissolved in includes hexanol in addition to dimethyl sulfoxide.

### Example 6

Example 6 is prepared using a method similar to Example 1, except the solvent system 4,4′-diaminodiphenyl ether is dissolved in includes aromatic naphtha in addition to dimethyl sulfoxide.

### Comparative Example 1

Comparative Example 1 is prepared using a method similar to Example 1, except pyromellitic dianhydride is added to yield a molar ratio of pyromellitic dianhydride to 4,4′-diaminodiphenyl ether added that is 1:1.

### Comparative Example 2

Comparative Example 2 is prepared using a method similar to Example 1, except the solvent system consists of dimethylformamide instead of dimethyl sulfoxide and pyromellitic dianhydride is added to yield a molar ratio of pyromellitic dianhydride 4,4′-diaminodiphenyl ether that is 1:1.

The data collected in Table 1 was performed by casting and chemically curing thin films of approximately 25 micron thickness in the laboratory using standard industry methods. The films were then cut into 0.5 inch strips and tested on an Instron 4464 model tensile tester for the physical properties of tensile strength, percent elongation, and modulus. Testing was performed following standard ASTM D-882 procedures.

TABLE 1
Material Properties

| | Molar Ratio of | Tensile | Elonga- | Young's | |
|---|---|---|---|---|---|
| | Dianhydride | Strength | tion | Modulus | Modulus |
| Example | and Diamine | (psi) | (%) | (ksi) | (ksi) |
| Example 1 | 0.97:1 | 23525 | 71.2 | 425 | 428 |
| Example 2 | 0.98:1 | 21882 | 72.3 | 401 | 400 |
| Example 3 | 0.995:1 | 24591 | 80.1 | 355 | 366 |
| Comparative | 1:1 | 24689 | 73.1 | 415 | 420 |
| Example 1 | | | | | |
| Comparative | 1:1 | 25700 | 71.2 | 399 | 439 |
| Example 2 | | | | | |

Table 1 shows that decreasing the molar ratio of dianhydride to diamine thereby decreasing the molecular weight of the polyamic acid does not significantly affect the material properties of the polyamic acid resin in REACH-approved solvent systems. Example 1, 2, and 3 are polyamic acid resins according to the first embodiment of the present invention with material properties that are acceptable for use in wire coating applications.

The data collected in Table 2 was measured by placing ˜200 g of varnish at ˜20° C. into a beaker and testing the viscosity using a Brookfield HADV-I+ viscometer. The spindle type and rotational speed values were adjusted to maintain a viscometer reading range within 25% to 75% for improved consistency.

TABLE 2
Viscosity of Examples

| Example | Viscosity | |
|---|---|---|
| Example 1 | 11.64 | poise |
| Example 2 | 32.24 | poise |
| Example 3 | 192 | poise |
| Example 4 | 6.64 | poise |
| Example 5 | 14.40 | poise |
| Example 6 | 15.40 | poise |
| Comparative Example 1 | 382 | poise |
| Comparative Example 2 | 19.5 | poise |

Target viscosities for wire coating applications typically run between 5 to 500 poise and more preferably between 5 to 100 poise. As shown in Table 2 the Examples 1, 2, 4, 5, 6, and Comparative Example 2 all have a viscosity in the preferred viscosity range. Example 3 is slightly higher than preferred viscosity, due to the 0.995:1 molar ratio of dianhydride to diamine of this sample. Comparative Example 1 with equimolar ratios of diamine to dianhydride has viscosities significantly higher than preferred and cannot be used by traditional existing wire coating equipment.

A copper adhesion test was designed to ensure reasonable adhesion to copper with the new formulations. The adhesion test was performed by applying a thin layer approximately 0.002 inches in thickness of resin to an untreated copper surface and then running the coating through a specific heat cycle in an oven. The level of adhesion was graded from 0 correlating to no adhesion to 10 correlating to the highest adhesion level possible. The results of the experiment are shown in Table 3.

TABLE 3
Wire Coating Quality and Appearance

| | | | | | | Comparative |
|---|---|---|---|---|---|---|
| | | | | | Example 6 | Example 2 |
| | | | | Example 5 | (0.97:1, with | (1:1, non- |
| | Example 4 | Example 2 | Example 3 | (0.97:1, with | Aromatic | REACH |
| Oven Conditions | (0.96:1) | (0.97:1) | (0.98:1) | Hexanol) | Naphtha) | solvent) |
| 240 sec at 140° C., | 1 | 1 | 1 | 3 | 4 | — |
| 20 sec at 350° C., | | | | | | |
| 120 sec at 450° C. | | | | | | |
| 240 sec at 150° C., | 6 | 7 | 8 | 3 | 4 | — |
| 20 sec at 350° C., | | | | | | |
| 120 sec at 450° C. | | | | | | |
| 240 sec at 160° C., | 8 | 10 | 9 | 3 | 7 | — |
| 20 sec at 350° C., | | | | | | |
| 120 sec at 450° C. | | | | | | |
| 240 sec at 170° C., | 10 | 10 | 9 | 3 | 8 | — |
| 20 sec at 350° C., | | | | | | |
| 120 sec at 450° C. | | | | | | |
| 240 sec at 180° C., | 9 | 9 | 8 | 3 | 6 | — |
| 20 sec at 350° C., | | | | | | |
| 120 sec at 450° C. | | | | | | |
| 240 sec at 190° C. | 8 | 7 | 7 | 4 | — | — |
| 20 sec at 350° C. | | | | | | |
| 120 sec at 450° C. | | | | | | |
| 240 sec at 200° C. | 4 (Blisters) | 3 (Blisters) | 3 (Blisters) | 8 | — | 9 |
| 20 sec at 350° C. | | | | | | |
| 120 sec at 450° C. | | | | | | |
| 240 sec at 210° C. | 6 (Blisters) | 6 (Blisters) | 4 (Blisters) | 4 | — | — |
| 20 sec at 350° C. | | | | | | |
| 120 sec at 450° C. | | | | | | |

Values above 7 in Table 3 represent good adhesion to copper and values below 3 represent poor levels of adhesion. REACH-approved resins in Table 3 typically showed the best adhesion levels when the initial oven temperatures were between 160 and 200° C. Blisters in the REACH-approved resin was typical in initial temperatures 200° C. and above in testing. Example 5, which contained a reactive co-solvent, hexanol, did not blister as badly as other examples with a single solvent system at high oven temperatures. Example 6 with a non-reactive co-solvent, aromatic naphtha, showed best adhesion at lower temperatures than single solvent systems. Non-REACH-approved resins are typically used with initial temperatures above 200° C. in industry. The non-REACH-approved resin, Comparative Example 2, showed good adhesion when tested with initial temperatures at 200° C. The heat adjustments needed for REACH-approved resins tested in this experiment are within the acceptable ranges for standard wire coating processing equipment.

1. A method for preparing polyamic acid, comprising:
reacting a dianhydride and a diamine at a molar ratio of 0.95 to 0.99:1.

2. Polyamic acid, obtained by reacting a dianhydride and a diamine at a molar ratio of 0.95 to 0.99:1.

3. A polyamic acid resin composition, comprising:
polyamic acid obtained by reacting a dianhydride and a diamine at a molar ratio of 0.95 to 0.99:1; and
at least one solvent approved under the Registration, Evaluation, Authorization, Restriction of Chemicals (REACH) regulation (REACH-approved solvent).

4. The polyamic acid resin composition of claim 3, wherein the at least one REACH-approved solvent comprises 80 to 100 wt % of a primary solvent and 0 to 20 wt % of a secondary co-solvent.

5. A method for coating a wire, comprising:
applying the polyamic acid resin composition of claim 3 onto a surface of a wire.
